(19) United States
(12) Patent Application Publication
(10) Pub. No.: US 2008/0006124 A1
(43) Pub. Date: Jan. 10, 2008

(54) Locating Device for a One-Way Ratchet Tool

(76) Inventor: Heng-Jian Weng, Jiang Su Province (CN)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/690,084

(22) Filed: Mar. 22, 2007

Related U.S. Application Data
(63) Continuation-in-part of application No. 11/456,540, filed on Jul. 10, 2006, now abandoned.

(51) Int. Cl. B25B 13/46

(52) U.S. Cl. 81/63

(57) ABSTRACT

A locating device for a one-way ratchet tool includes a lid, a ratchet, a detent, a resilient element and a wrench body. The wrench body comprises a chamber and a recess to accommodate the ratchet, the detent and the resilient element which are covered by the lid. The elastic element is disposed between the detent and the wrench body. The wrench body has its inner wall engaging with the detent to secure the detent in place to provide a precise and simple locating device for a one-way ratchet tool.

### CROSS-REFERENCE TO RELATED APPLICATIONS

This application is a continuation-in-part of U.S. patent application Ser. No. 11/456,540, filed on Jul. 10, 2006, which is hereby incorporated by reference in its entirety.

Although incorporated by reference in its entirety, no arguments or disclaimers made in the parent application apply to this divisional application. Any disclaimer that may have occurred during the prosecution of the above-referenced application(s) is hereby expressly rescinded. Consequently, the Patent Office is asked to review the new set of claims in view of all of the prior art of record and any search that the Office deems appropriate.

### FIELD OF THE INVENTION

The present invention relates to a locating device for a one-way ratchet tool, in particular to one having a resilient element provided between a detent and a wrench body, with the inner wall of the wrench body engaging with the detent to provide a precise locating device.

### BACKGROUND OF THE INVENTION

There are many ratchet hand tools on the market, such as U.S. Pat. Nos. 6,145,412, and 6,263,767 (all of which are hereby incorporated by reference in their entirety). The former patent uses gears meshing to secure the position of a ratchet, which is complicated in structure. The latter patent is not able to provide a precise position.

Thus, there is still a need for ratchet hand tool that provides precise positioning using relatively simple component parts, and more preferably a hand tool with component parts that provides relative stability and integrity to minimize jamming of component parts.

All referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply. The invention may seek to satisfy one or more of the above-mentioned desire. Although the present invention may obviate one or more of the above-mentioned desires, it should be understood that some aspects of the invention might not necessarily obviate them.

### SUMMARY OF THE INVENTION

A locating device for a one-way ratchet tool according to the present invention is to use a resilient element provided between a detent and a wrench body. The detent engages with the inner wall of the wrench body to provide a precise locating device for a one-way ratchet tool.

The present invention comprises a lid, a ratchet, a detent, a resilient and a wrench body; said lid comprising a first reduced section and a fastener corresponding to said first reduced section; said ratchet comprising a through hole to receive a corresponding tool, said ratchet further comprising gear teeth and a second reduced section around its outer periphery; said detent comprising a front end, a relative rear end and a substantially flat side between said front end and said rear end, said front end being formed with gear teeth corresponding to said gear teeth of said ratchet; said resilient element comprising a first end and a second end. Among the many possibilities contemplated, the first end of the resilient element can movably engage with said side of said ratchet such that said first end is laterally movable across a distance on the flat side and not fixedly engaged at a particular point on said flat side. Further said second end engages with said wrench body, and said wrench body comprises a chamber, a recess, a block ring and a groove, said recess interconnecting with said chamber, said block ring being disposed in a lower portion of said wrench body, said groove being disposed in an upper portion of said wrench body, said ratchet being accommodated in said chamber and confined by said block ring, said detent and said resilient element being accommodated in said recess, said lid covering said second reduced section of said ratchet, said detent and said resilient element, said fastener being disposed on said first reduced section and inserted into said groove to confine said lid from detachment.

The wrench body has its inner wall engaged with the detent to secure the detent in place so as to link the wrench body and the tool head in the wrench body to accomplish the function.

### BRIEF DESCRIPTION OF THE DRAWINGS

FIG. 1 is an exploded view of the present invention;

FIG. 2 is a perspective view of the present invention; and

FIG. 3 is a top cross-sectional view of the present invention in an operating status.

### DETAILED DESCRIPTION OF THE PREFERRED EMBODIMENT

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

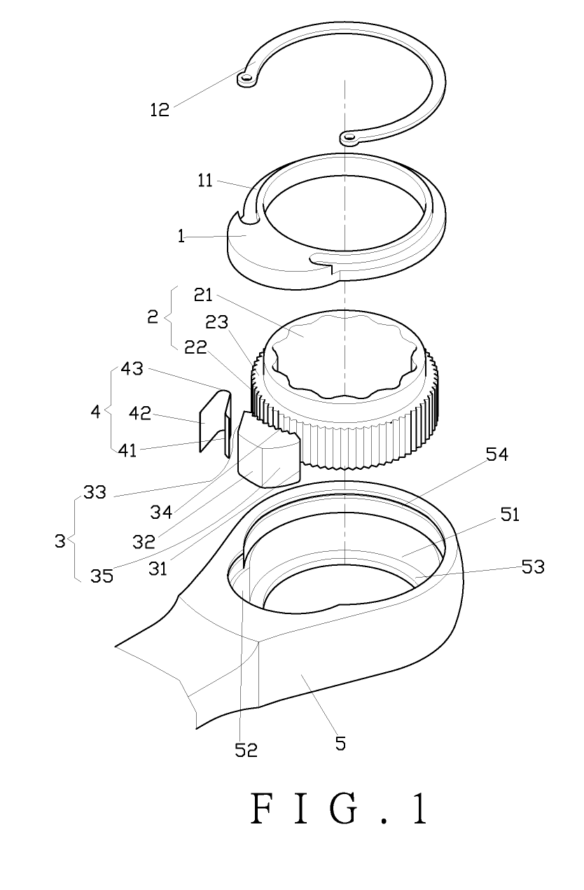

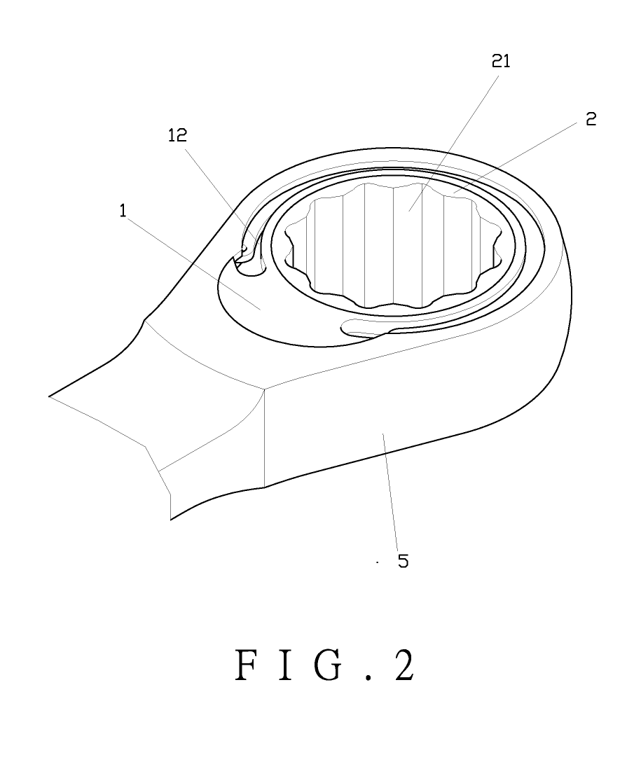

As shown in FIGS. 1 and 2, a preferred embodiment of the present invention comprises a lid 1, a ratchet 2, a detent 3, a resilient element 4 and a wrench body 5.

The lid 1 comprises a C-shaped first reduced section 11 and a fastener 12 corresponding in position to the first reduced section 11. The fastener 12 is a C-shaped clip.

The ratchet 2 comprises a through hole 21 to receive a corresponding tool (a conventional screwdriver head/hexagonal sleeve, not shown in the drawings). The ratchet 2 is provided with gear teeth 22 and a second reduced section 23 around its outer periphery.

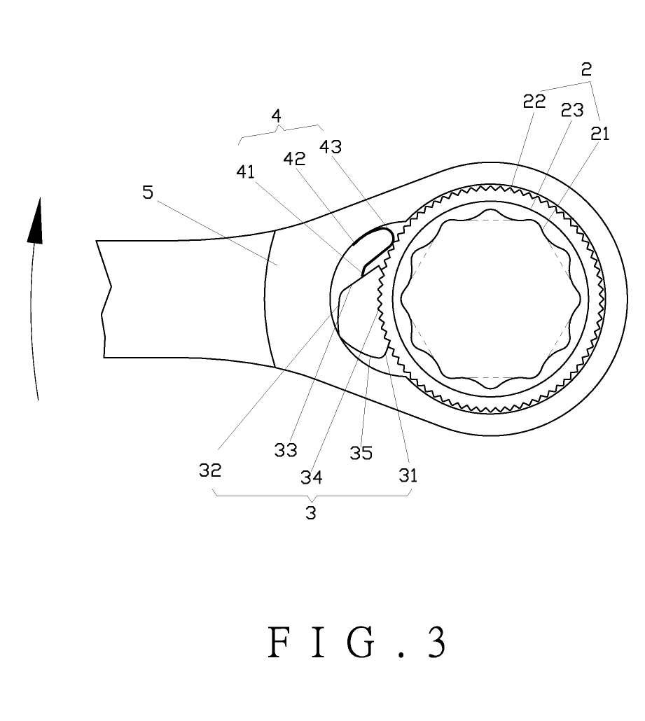

Contemplated detent can have any suitable longitudinal cross-sectional shape. As used herein, the longitudinal direction in conjunction with the detent refers to the direction substantially parallel to the direction of travel of the detent. In other words, the longitudinal direction in conjunction with the detent refers to a direction substantially parallel to the line representing rear end 32 in FIG. 3. In one preferred aspect of the inventive subject matter, the detent 3 comprises a front end 31, a relative rear end 32 and a substantially flat side 33 between the front end 31 and the rear end 32. Most or all of the front end 31 is formed with gear teeth 34 corresponding to the gear teeth 22 of the ratchet 2. As shown more clearly in FIG. 3, the part numeral 31 indicates one embodiment where the entire side of the detent that is covered with gear teeth 34. In one contemplated embodiment, the detent 3 has a longitudinal cross-sectional shape that is generally quadrilateral. In another contemplated embodiment as shown in the figures, the longitudinal cross-sectional shape is generally trapezoidal. The goal is to have a longitudinal cross-sectional shape to minimize contact with the wall of the recess 52. As illustrated in FIGS. 1 and 3, a generally trapezoidal detent allows only one single point of contact with the recess wall, at the ridge formed at the lower end of rear end 32 as shown in FIG. 3. Contrary to public belief where maximum contact is desired to support the detent when turning the wrench in the clock-wise direction as shown by the arrow in FIG. 3, in the current invention, it is discovered that minimizing contact area allows freer movement of the detent, and even allows the detent to pivot, tilt, move out of alignment with gear teeth 22 of the ratchet 2, and readjust itself to mesh with the gear teeth 22 of the ratchet 2 for better alignment. One of ordinary skilled in the art would recognize that other shapes can be implemented to allow freer movement of the detent as described herein. Also, such feature can be optional, and a typically-shaped detent can be used which has more contact areas of the recess wall than that described herein.

The detent 3 further comprises a second side 35 between the front end 31 and the rear end 32. The resilient element 4 comprises a first end 41 and a second end 42. The first end 41 movably engages with the flat side 33 of the detent 3 such that the first end 41 is laterally movable across a distance on the flat side 33 and not fixedly engaged at a particular point on the flat side 33. In operation, when the wrench in FIG. 3 is turned in a counter-clock-wise direction (opposite of the arrow in the figure), as the detent 3 is forced to move toward the resilient element 4, the first end 41 slides across the surface of flat side 33. Allowing the free sliding minimizes jamming of the component parts. It should be noted that the flat side 33 can be curved, or retain other shapes, so long as the first end can have some distance of travel across the side 33. The second end 42 engages with the wrench body 5. The resilient member 4 can be any suitable spring, and is preferably a flat leaf spring having a c-shaped arch 43, and the spring is positioned such that an opening of the c-shaped arch 43 faces away from the ratchet 2. This configuration is important because if the opening of the c-shaped arch faces the ratchet 2, when the leaf malfunctions and becomes loose, one of the two ends of the spring will come in contact with gears 22 of the ratchet 2, and possibly causing a jam. And if the user forcibly turns the wrench in a clock-wise direction (see arrow) as in FIG. 3, the end of the leaf spring may even be drawn into the space between the detent 3 and the ratchet 2, causing further damage. The leaf spring preferably has a width substantially similar to the width of the detent as shown in FIG. 1 for better support. The width of the detent is defined by the length of the ridge intersected by side 33 and rear end 32.

The wrench body 5 comprises a chamber 51, a recess 52, a block ring 53, and a groove 54 therein. The recess 52 interconnects with the chamber 51. The block ring 53 is disposed in a lower portion of the wrench body 5, and the groove 54 is disposed in an upper portion of the wrench body 5. The ratchet 2 is accommodated in the chamber 51 and confined by the block ring 53. The detent 3 and the resilient element 4 are accommodated in the recess 52. As discussed earlier for some preferred embodiments, the detent 3 is abutted against a wall of the recess 52 by the spring 4, and the only part of detent 3 that engages with the wall is a ridge formed between the second side 35 and the rear end 32. The lid 1 covers the second reduced section 23 of the ratchet 2, the detent 3 and the resilient element 4. The fastener 12 is disposed on the first reduced section 11 of the lid 1 and inserted into the groove 54 to restrain the lid 1 from detachment.

As shown in FIG. 3, the wrench body 5 has its inner wall engaging with the detent 3 to secure the detent 3 in place so as to link the wrench body 5 and the tool head in the wrench body 5 to accomplish the function.

Thus, specific embodiments and applications of locating device for a one-way ratchet tool have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A locating device for a one-way ratchet tool comprising a lid, a ratchet, a detent, a resilient element and a wrench body;
said ratchet comprising a through hole to receive a corresponding tool, said ratchet further comprising gear teeth and a second reduced section around its outer periphery;
said detent comprising a front end, a relative rear end and a substantially flat side between said front end and said rear end, said front end being formed with gear teeth corresponding to said gear teeth of said ratchet; and
said resilient element comprising a first end and a second end, said first end movably engages with said flat side of said ratchet such that said first end is laterally movable across a distance on the flat side and not fixedly engaged at a particular point on said flat side.

2. The locating device for a one-way ratchet tool, as recited in claim 1, wherein said fastener is a C-shaped clip, and wherein said lid is comprised of a first reduced section and a fastener corresponding to said first reduced section.

3. The locating device for a one-way ratchet tool, as recited in claim 2, wherein said first reduced section is C-shaped, and said wrench body comprises a chamber, a recess, a block ring and a groove, said recess interconnects with said chamber, said block ring being disposed in a lower portion of said wrench body, said groove being disposed in an upper portion of said wrench body, said ratchet being accommodated in said chamber and confined by said block ring, said detent and said resilient element being accommodated in said recess, said lid covering said second reduced section of said ratchet, said detent and said resilient element, said fastener being disposed on said first reduced section and inserted into said groove to confine said lid from detachment.

4. The locating device for a one-way ratchet tool, as recited in claim 1, wherein the resilient element is a flat leaf spring having a c-shaped arch, and wherein the spring is positioned such that an opening of the c-shaped arch faces away from the ratchet.

5. The locating device for a one-way ratchet tool, as recited in claim 4, wherein a longitudinal cross-sectional shape of said detent is generally quadrilateral.

6. The locating device for a one-way ratchet tool, as recited in claim 5, wherein the longitudinal cross-sectional shape is generally trapezoidal.

7. The locating device for a one-way ratchet tool, as recited in claim 6, wherein the detent further comprises a second side between said front end and said rear end, wherein the detent is abutted against a wall of the recess by said spring, and wherein a ridge disposed between said rear end and said second side is abutted against the wall.

8. A one-way wrench tool comprising:
a wrench body having a chamber and a recess;
a ratchet located within the chamber, wherein the ratchet has gears;
a detent with gears capable of meshing with gears of the ratchet, wherein the detent has a longitudinal cross-sectional shape that is generally trapezoidal; and
a resilient element that biases the detent against a wall of the recess.

9. The tool as recited in claim 8, wherein the resilient element is a flat spring, and has a c-shaped arch, wherein an opening of the c-shaped arch faces away from the ratchet.

10. The tool as recited in claim 9, wherein the flat spring movably connects with the detent such that when the detent is moved by the ratchet, a contact point of the flat spring slidably moves across a surface of the detent.

11. The tool as recited in claim 10, where in the flat spring is not fixedly attached to the detent.

12. A wrench comprising:
a wrench body;
a geared ratchet inside of said wrench body;
a detent having gears that correspondingly mesh with the geared ratchet;
a resilient element coupled to the detent and the wrench body;
wherein the resilient element has an arch forming an opening; and
wherein the opening faces away from the ratchet.

13. The wrench of claim 12, wherein the arch is a c-shaped arch.

14. The wrench of claim 13, wherein the resilient element is a flat leaf spring.

15. The wrench of claim 14, wherein the detent has a longitudinal cross-section shape that is generally quadrilateral.

16. The wrench of claim 15, wherein the detent has a longitudinal cross-section shape that is generally trapezoidal.

17. The wrench of claim 16, wherein the flat spring is slidably coupled to the detent such that when the detent moves relative to a position of the flat spring, a contact point of the spring moves across a surface of the detent, and not fixedly attached to the detent at any particular point.
